(19) United States
(12) Patent Application Publication
(10) Pub. No.: US 2025/0165772 A1
(43) Pub. Date: May 22, 2025

(54) Efficient Localization Using Graph Neural Networks

(71) Applicant: PayPal, Inc., San Jose, CA (US)

(72) Inventors: Zhe Chen, Singapore (SG); Jiazheng Zhang, Singapore (SG); Md Muhim Muktadir Khan, Singapore (SG); Ryuto Sunaga, Singapore (SG); Giovanni Saavedra Bacalso, Singapore (SG); Harshini Garikiparthi, Bengaluru (IN)

(21) Appl. No.: 18/515,561

(22) Filed: Nov. 21, 2023

(51) Int. Cl. G06N 3/08

(52) U.S. Cl. CPC G06N 3/08

(57) ABSTRACT

Techniques are disclosed relating to using graph neural networks to identify locations in a hierarchical data set. In various embodiments, a computing system receives a request to identify, in a data set having a hierarchical structure, one or more locations corresponding to a description specified by the request. The computing system assembles, from the data set, a graph data structure that includes nodes corresponding to locations in the data set and interconnected by edges preserving the hierarchical structure. The computing system applies a graph neural network algorithm to the graph data structure to generate location embeddings for the nodes and identifies the one or more locations by determining similarities between the generated location embeddings and a description embedding representative of the description.

### BACKGROUND

### Technical Field

This disclosure relates generally to computer systems and, more specifically, to machine learning algorithms using graph neural networks.

### Description of the Related Art

Enterprises are increasingly utilizing machine learning to enhance the services that they provide to their users. Using machine learning techniques, a computer system can train models from existing data and then use them to identify similar trends in new data. In some cases, the training process is supervised in which the computer system is provided with labeled data that it can use to train a model. For example, a model for identifying spam can be trained based on emails that are labeled as either spam or not spam. Examples of supervised learning algorithms include linear regression, logistic regression, and support vector machines. In other cases, the training process can be unsupervised in which the computer system is provided with unlabeled data that it can use to train a model to discover underlying patterns in that data. Unsupervised training may be favored in scenarios in which obtaining labeled data is difficult, costly, and/or time-consuming.

### BRIEF DESCRIPTION OF THE DRAWINGS

FIG. 1 is a block diagram of one embodiment of a system that is capable of identifying a location within a hierarchical data set corresponding to a description specified by a request.

FIG. 2 is a block diagram of one embodiment of a graph assembler that is capable of constructing a hierarchical graph from a hierarchical data set.

FIG. 3 is a block diagram of one embodiment of a graph neural network algorithm that is capable of encoding a hierarchical graph into location embeddings.

FIG. 4 is a block diagram of one embodiment of a description encoder that is capable of encoding a location request into a description embedding.

FIG. 5 is a block diagram of one embodiment of a comparison engine that is capable of producing a location that corresponds to a description specified by a request.

FIG. 6 is a block diagram of one embodiment of a system that is capable of training and updating the weights of the machine learning model.

FIGS. 7-9 are flow diagrams illustrating embodiments of methods implementing techniques described herein.

FIG. 10 is a block diagram illustrating elements of an exemplary computer system for implementing techniques described herein.

### DETAILED DESCRIPTION

When using a software application, it is not uncommon for a user to experience an unexpected error caused by a software bug. For example, a software bug resulting from a coding error may cause the software application to unexpectedly crash. As a result, the user is often prompted to fill out and submit an error report which is used to address the bug. An error report includes information about the error, such as a title and description, and is used by developers to identify the underlying problem located within code that caused the bug. For example, an error report may include a textual description provided by the user that describes the circumstances behind a software crash. Accordingly, developers analyze the textual description in order to manually locate and correct the problematic segment of code. However, the process of manually locating specific data segments within a dataset can be challenging and time-consuming, causing longer average handling times (AHT).

The present disclosure describes embodiments in which a computer system is used to locate a segment of data within a dataset based on a description specified in a request. As will be described below in various embodiments, the system can receive a request to identify, in a data set having a hierarchical structure, one or more locations corresponding to a description specified by the request. For example, in a software development context, a request may include a report identifying symptoms of an unexpected bug in a software application in order to identify segments of code that are potentially relevant to the symptoms and where a correction can be made. As another different example, in an e-discovery context, a request may be received to identify locations in documents (e.g., pdfs, email chains, etc.) relevant to a lawsuit and include a description including words or phrases associated the lawsuit. As part of identifying one or more locations, the system assembles a hierarchical graph from the data set, using nodes interconnected by edges. A node, in various embodiments, includes an embedding that represents a data segment at a particular location in the data set while the edges correspond to the data segment's relationships with other data segments/nodes. For example, the node may represent a particular function in source code while an edge connected to the node represents its dependency on a second function such as including a function call to the second function, exchanging data with the second function, sharing a synchronization primitive with the second function, etc. The system then applies a graph neural network algorithm to the hierarchical graph to generate location embeddings from the plurality of nodes. The system compares the generated location embeddings to the description embedding to produce similarity scores and identifies one or more locations within the dataset based on the scores. In many instances, this approach is far more efficient than other approaches such as performing word searches on a data set, manually walking through the data set by hand, etc.

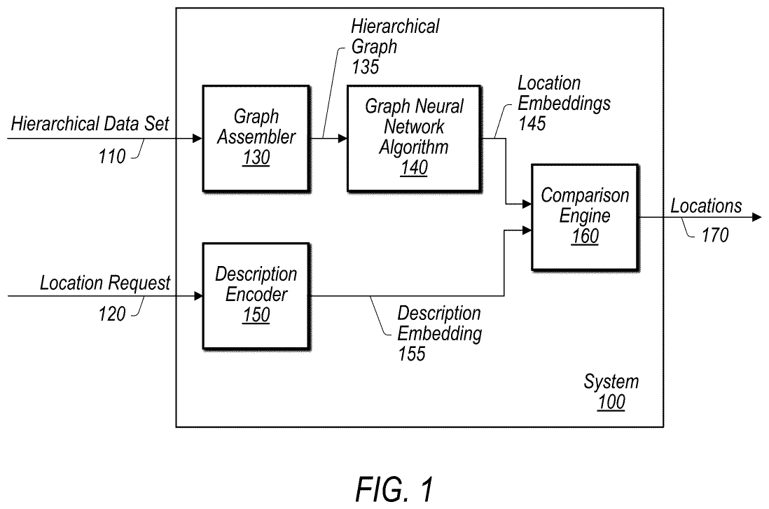

Turning now to FIG. 1, a block diagram of system 100 is shown. System 100 includes a set of components that may be implemented via hardware or a combination of hardware and software routines. In the illustrated embodiment, system 100 includes a graph assembler 130, graph neural network algorithm 140, description encoder 150, and comparison engine 160. As further shown, system 100 receives a hierarchical data set 110 and a location request 120. The illustrated embodiments may be implemented differently than shown. As an example, system 100 may include a preprocessing engine for preprocessing hierarchical data set 110 and location request 120.

System 100, in various embodiments, is a system that identifies locations 170 in a hierarchical data set 110 based on a description provided by a location request 120. In some embodiments, system 100 is part of a platform that provides one or more services (e.g., a cloud computing service, a customer relationship management service, and a payment processing service) that are accessible to users that can invoke functionality of the services to achieve a user-desired objective. To facilitate the functionality of those services, system 100 may execute various software routines, such as comparison engine 160, as well as provide code, web pages, and other data to users, databases, and other entities that use system 100. In various embodiments, system 100 is implemented using a cloud infrastructure that is provided by a cloud provider. Components of system 100 may thus execute on and use cloud resources of that cloud infrastructure (e.g., computing resources, storage resources, etc.) to facilitate their operation. For example, software that is executable to implement graph assembler 130 may be stored on a non-transitory computer-readable medium of server-based hardware included in a datacenter of the cloud provider. That software may be executed in a virtual environment that is hosted on the server-based hardware. In some embodiments, system 100 is implemented using a local or private infrastructure as opposed to a public cloud.

The generation of locations 170 can involve the use of various software modules. As shown, system 100 comprises graph assembler 130, graph neural network algorithm 140, description encoder 150, and comparison engine 160.

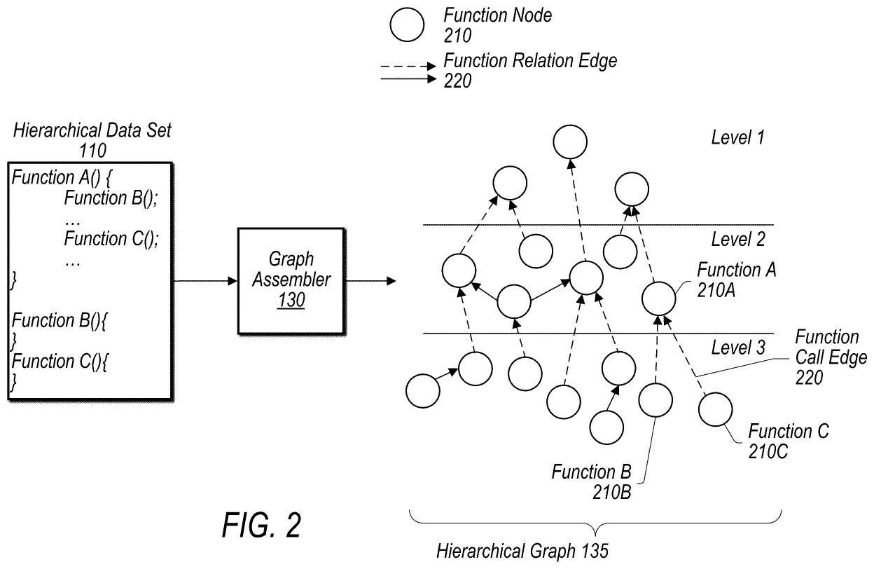

Graph assembler 130, in various embodiments, is software executable to construct a hierarchical graph 135 from a hierarchical data set 110, using nodes and edges. Hierarchical data set 110 may correspond to any suitable data set having a hierarchical structure in which individual data segments can be linked together based on respective relationships, dependencies, etc. For example, in various embodiments, data set 110 is source code for an application that includes higher-level functions making calls a sub-set of lower-level functions to perform various operations. As another example, data set 110 may be one or more websites in which individual webpages are interconnected using hyperlinks. As yet another example, data set 110 may be a large document (or large collection of documents) that includes multiple sections with cross referencing to other sections. As will be discussed with FIG. 2, graph assembler 130 can assemble a hierarchical graph 135 that includes nodes corresponding to locations in data set 110 and interconnected edges to preserve this hierarchical structure for subsequent processing. As shown, graph assembler 130 provides hierarchical graph 135 to graph neural network algorithm 140.

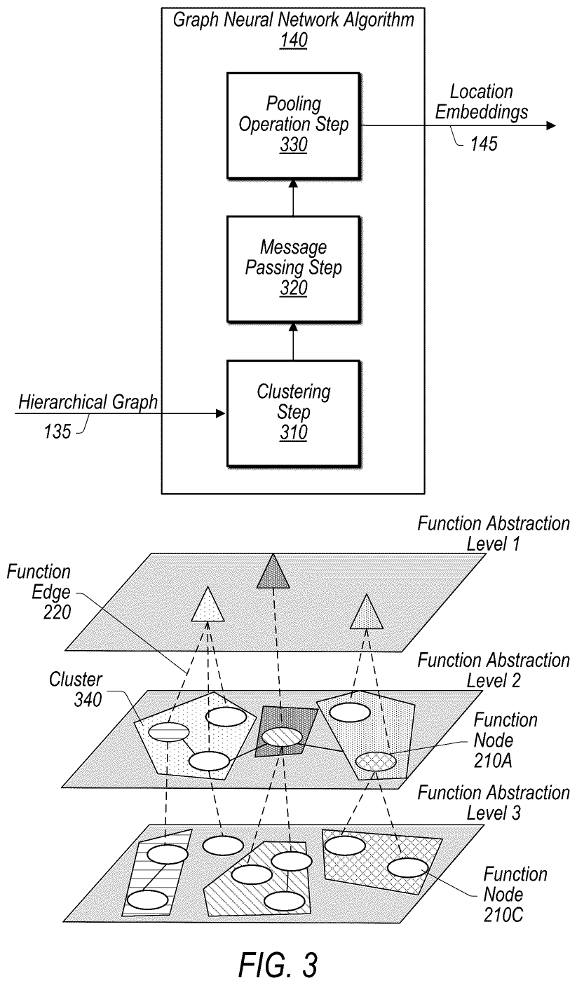

Graph neural network algorithm 140, in various embodiments, is software executable to process hierarchical graph 135, using one or more neural networks, to produce location embeddings 145. Location embeddings 145 are mathematical representation of particular data segments and their particular locations, expressed as vectors in space. For example, in a software development context, a location embedding 145 may be a vector that represents the code (or other attributes) included in a particular function and the dependencies of that function. As will be discussed with FIG. 3, graph neural network algorithm 140 can determine node embeddings for nodes in the graph data structure and, based on their interconnected edges, assign the nodes to pooling layers used to determine location embeddings that preserve both the content in a node as well as its relationships within hierarchal data set 110. As shown, graph neural network algorithm 140 provides location embeddings 145 to comparison engine 160.

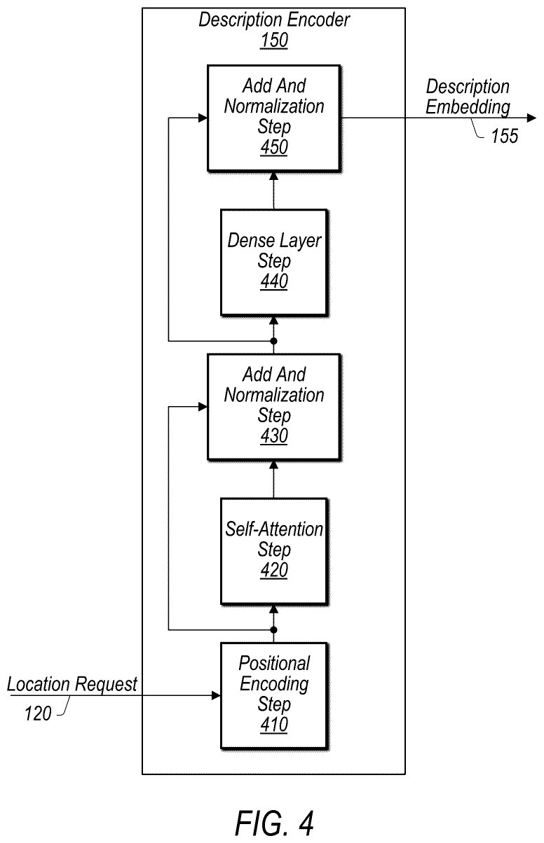

Description encoder 150, in various embodiments, is software executable to encode a textual description from location request 120 into a description embedding 155. Location request 120 may include any suitable a textual description that can be used to identify one or more locations in data set 110. For example, in a software development context, location request 120 may describe attributes, which may be relevant to a particular segment of code, such as the context in which a bug was discovered, the actions being requested by the user at the time, a description of an undesired behavior, etc. Description embedding 155, in various embodiments, represents the content of the textual description in a single vector. As will be discussed with FIG. 4, description encoder 150 may apply a trained machine learning language model (e.g., Bidirectional Encoder Representations from Transformers (BERT), Generative Pre-trained Transformer (GPT), etc.) to the description to determine a description embedding 155. As shown, description encoder 150 provides description embedding 155 to comparison engine 160.

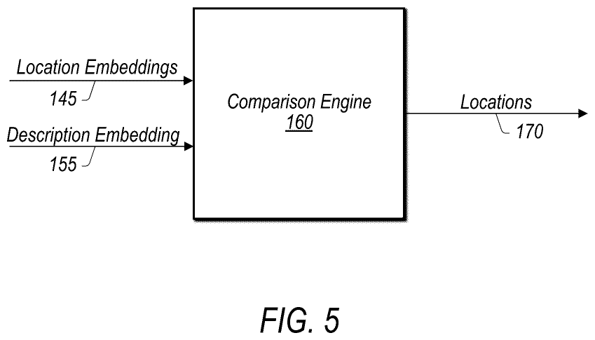

Comparison engine 160, in various embodiments, is software executable to identify locations 170 based on a comparison between location embeddings 145 and description embedding 155. Locations 170 correspond to locations within hierarchal data set 110 that are determined to be relevant to the description in location request 120 based on determined similarity scores. Comparison engine 160 is discussed in greater detail with respect to FIG. 5. Based on locations 170, in some embodiments, developers can quickly identify and correct problematic sections of code, and subsequently, significantly reduce the AHT for resolving an error repot.

Turning now to FIG. 2, a block diagram of an example of graph assembler 130 constructing a hierarchical graph 135 from hierarchical data set 110. In the illustrated embodiment, graph assembler 130 receives hierarchical data set 110 that includes application source code. In other embodiments, however, graph assembler 130 may assemble a graph 135 using other types of hierarchical data as noted above.

As shown, the example source code in hierarchical data set 110 includes a set of functions A. B. and C in which function A includes a first function call to function B and a second function call to function C. For example, function A may need to perform a general task and may invoke functions B and C to perform some subtasks. These functions calls represent relationships that create a hierarchical structure in which function A may be considered a higher-level function due to its position in the call graph while functions B and C may be considered lower-level functions. Other relationships, such as passing data, sharing semaphores, referencing common libraries, accessing the same memory addresses, using the same resources, etc., may also reflect hierarchical structure within data set 110. Graph assembler 130 attempts to preserve these relationships in hierarchical graph 135 through adding edges 220.

In various embodiments, graph assembler 130 begins constructing graph 135 by providing hierarchical data set 110 to a preprocessing engine to encode data segments, using feature extraction techniques, to produce an initial set of embeddings for inclusion in nodes 210. This preprocessing engine may initially convert data segments into a set of tokens using tokenization. For example, the preprocessing engine may convert the various keywords included in the source code for functions A, B, and C into a sequence of tokens. The preprocessing engine may then transform the tokens into vector representations and provides them to an encoder model (e.g., BERT, GPT, etc.), which may be implemented in a similar manner as encoder mode 150 discussed below. The encoder model encodes the vectors, using one or more neural network, into weighted embeddings that represent the features of the data segments. For example, different sets of weighted embeddings may represent the code features of functions A, B, and C.

In various embodiments, graph assembler 130 inserts generated embeddings into nodes 210 that are interconnected using edges 220 based the nodes 210's relationships to construct hierarchical graph 135. For example, in the illustrated embodiment, graph 135 includes function nodes 210A-C that include the node embeddings for function A-C, respectively. Because function A calls functions B and C, corresponding edges 220 are added to connect node 210A to nodes 210B and 210C. Depending on a particular node 210's placement in graph 135, nodes 210 may be regarded as residing at one of multiple abstract levels. Accordingly, function A's node 210A corresponds to the highest level of abstraction on level 2 while function C's node 220C corresponds to a lower level of abstraction located on level 3. As will be discussed, these different levels/layers may be used to selectively apply differential pooling on node embeddings in order preserver relationships between nodes 210 at different levels.

Turning now to FIG. 3, a block diagram of an example of graph neural network algorithm 140 is shown. In the illustrated embodiment, graph neural network algorithm 140 includes a clustering step 310, a message passing step 320, and a pooling operation step 330. In some embodiments, graph neural network algorithm 140 is implemented differently than shown. As an example, graph neural network algorithm 140 may include a softmax and/or normalization step.

Graph neural network algorithm 140, in various embodiments, uses one or more neural networks to process hierarchical graph 135 in order to update the initial node embedding included in each node 210 based on the embeddings of their respective neighboring nodes 210 as indicated by edges 220. In the illustrated embodiment, algorithm 140 begins with clustering step 310.

In the clustering step 310, algorithm 140 groups nodes 210 into clusters 340, using a clustering technique such as a cluster assignment matrix. The parameters for the cluster assignment matrix may be determined based on the abstraction levels in which nodes 210 reside and their interconnecting edges 220. For example, function A's node 210A resides on the abstraction level 2 while functions B's node 210B and functions C's node 210C reside on level 3. Because nodes 210B and node 210C reside on the same level 3 and are related due their common relationship with parent function A, nodes 210B and 210C may be assigned to the same cluster 340. In other embodiments, clusters 340 may be determined differently—and based on different relationships. After each node 210 is assigned to a cluster 340, algorithm 140 proceeds to message passing step 320. In some embodiments, message passing step 320 may be performed prior to clustering step 310.

In the message passing step 320, algorithm 140 updates each embedding for their respective node 210 by performing a message passing operation. A message passing operation includes passing “messages” containing information (embeddings) along the edges 220 of graph 135 in order to aggregate, using an aggregation function (e.g., sum, mean, etc.), the embeddings of neighboring nodes 210 with the embedding of a target node 210. A target node 210, in various embodiments, is a node 210 within the same cluster 340. For example, a target node 210 may be connected to two neighboring nodes 210 via edges 220 in a cluster 340, and thus, the embeddings of the two neighboring nodes 210 are passed as a “message” and aggregated with the initial embedding of the target node 210. For a directed graph 135 including unidirectional edges 220, the aggregation of each node 210 embedding, in various embodiments, is determined by the direction of edge 220. For example, a target node 210 may be connected to two neighboring nodes via one inbound and one outbound edge 220. When performing a message passing operation, algorithm 140 may only aggregate the embedding of the target node 210 with the embedding of the neighboring node 210 connected by the inbound edge 220.

After the aggregated embedding is generated for each target node 210, algorithm 140 may introduce linear transformations by applying a weight matrix to the aggregated embedding. For example, algorithm 140 may multiply the new aggregated representation of the target node 210 by a weighted value, resulting in a weighted embedding. In other embodiments, algorithm 140 may assign different weighted values to each individual node 210 of graph 135 based on a node's level of importance when compared to all nodes 210 prior to performing the message passing operation. For example, if algorithm 140 determines a first neighboring node 210 is more important relative to a second neighboring node 210 for a particular target node 210, algorithm 140 may assign a higher weighted value to the message of the first neighboring node. In other embodiments, the target node 210 may be transformed by applying a weight matrix to its initial vector representation prior to aggregating the target node 210's weighted embedding with the aggregated weighted embedding of the neighboring nodes 210. The parameters of the weight matrix may be initialized randomly and is updated through a training process.

After the linear transformation, algorithm 140, in various embodiments, uses a neural network to introduce non-linear transformations to the weighted aggregated embeddings for each target node 210, using an activation function such as Rectified Linear Unit (ReLU). An activation function determines if the node in the neural network is activated based on an activation value. For example, the node of a neural network may activate if the activation value from the activation function is a positive value. Otherwise, the node of the neural network with a negative value will not activate and thus will not produce an output. By introducing non-linear transformations, algorithm 140 identifies non-linear relationships in the graph data. Message passing step 320, in various embodiments, may be performed N times prior to preceding to step 330. After the representations for each node 210 is updated, algorithm 140 proceeds to pooling operation step 330.

In the pooling operation step 330, algorithm 140 introduces graph coarsening by performing a pooling operation, such as max, mean, or sum, to aggregate the embeddings of nodes 210 from a lower level with a target node 210 on a higher level, resulting in new location embedding 145 for the higher level node 210. Location embedding 145 represents the total content of a higher-level function (or other type of data segment in some embodiments) and its respective dependent lower-level functions (or other types of data segments) in a single vector. In some embodiments, the nodes 210 aggregated together for pooling are determined by clusters 340. For example, if a target node 210 located on abstraction level 1 is connected via edges 220 to three nodes 210 on abstraction level 2, algorithm 140 performs a pooling operation to aggregate the three nodes of level 2 with the target node 210 on level 1, resulting in a new vector representation for the target node 210. As a pooling operation abstracts the information captured in lower level nodes 210 into a higher level node 210, levels 1-3 are shown in FIG. 3 as “abstraction levels” and may be considered as “pooling layers.” Algorithm 140 may perform a pooling operation for each function containing subfunctions, resulting in a location embedding 145 per operation. In various embodiments, the pooling operation may be performed N−1 times based on N abstraction levels. After step 330, algorithm 140 provides location embeddings 145 to comparison engine 160.

Turning now to FIG. 4, a block diagram of an example of description encoder 150 is shown. In the illustrated embodiment, description encoder 150 includes a positional encoding step 410, a self-attention step 420, an add and normalization step 430, a feed-forward step 440, and an additional add and normalization step 450. As further shown, description encoder 150 receives location request 120. In some embodiments, description encoder 150 is implemented differently than shown. As an example, location request 120 may first be provided to a preprocessing engine prior to description encoder 150.

In some embodiments, a preprocessing engine prepares the textual description from location request 120, using preprocessing techniques such as tokenization, to produce an input suitable for description encoder 150. Tokenization breaks the textual description into smaller units called tokens. For example, the preprocessing engine may separate the textual description from location request 120 into individual words. The preprocessing engine, in various embodiments, converts the tokens into initial word embeddings to feed into description encoder 150.

In the illustrated embodiment, description encoder 150 begins with a positional encoding step 410. Description encoder 150 processes the word embeddings from location request 120 in parallel and thus to preserve their ordering, adds positional encodings to the input word embeddings. Accordingly, in positional encoding step 410, description encoder 150 encodes, for a word embedding, positional information describing that embedding's position within a sequence of word embeddings based on its position within a sentence from location request 120. As an example, the unique positional encoding associated with a particular word embedding may indicate that the particular word is the fourth word in a sentence. The positional encoding allows for description encoder 150 to distinguish the ordering of word embeddings in a sequence of words embeddings when using parallel computation. After producing positional aware word embeddings, description encoder 150 proceeds to a self-attention step 420

In step 420, description encoder 150 uses a neural network and attention mechanism (e.g., a self-attention layer) to determine which word embeddings from the description in location request 120 are the most important towards locating a section of data in hierarchal data set 110, resulting in weighted word embeddings. The self-attention layer weighs the importance of each word embedding in an input sequence and adjusts their influence on the output embedding. For example, the self-attention layer is used to evaluate each word embedding relative to the other word embeddings within the sequence and assigns a set of weights (e.g., numerical values) to each word embedding based on the embedding's determined level of importance towards locating a function being described by an error report. In some embodiments, the set of weights may be initialized randomly and are updated as the model learns to extract dependencies from the word embeddings through a training process (e.g., backpropagation). Backpropagation, in various embodiments, is used to update each weighted value to minimize prediction error. If the attention layer determines that a word embedding is more important, then the word embedding, in various embodiments, is assigned a higher value. In contrast, the attention layer assigns a lower value to word embeddings that are considered less important. The self-attention layer may produce a more context-aware embedding that captures linear relationships between word embeddings in the sequence. After generating a set of weighted embeddings, description encoder 150 proceeds with add and normalization step 430.

In step 430, description encoder 150 adds the original input of the self-attention layer to the output of the self-attention layer, using a residual connection. A residual connection, in various embodiments, allows the output from one layer (e.g., output from step 410) to skip one or more layers in description encoder 150 and is used to improve training by mitigating a vanishing gradient problem during backpropagation. After summing the resulting embeddings, in various embodiments, description encoder 150 normalizes those embeddings by scaling the magnitude of the embeddings to fit withing a numerical range. For example, description encoder 150 may scale an embedding so that the mean of the embedding is 0 with a standard deviation of 1. Description encoder 150 may also normalize the embeddings using normalizing techniques such as layer normalization. After normalizing the embeddings, description encoder 150 proceeds with dense layer step 440.

In step 440, description encoder 150 uses a neural network (e.g., a dense layer) to introduce non-linear transformations to the embeddings, using an activation function (e.g., Rectified Linear Unit). A dense layer is a layer where all the nodes in the layer of the neural network connect to all the nodes in the previous layer, and an activation function determines if the node in the neural network is activated based on an activation value. For example, the node of a neural network may activate if the activation value from the activation function is a positive value. Otherwise, the node of the neural network with a negative value will not activate and thus will not produce an output. By introducing non-linear transformations, description encoder 150 identifies non-linear relationships within location request 120. After step 440, description encoder 150 proceeds with another add and normalization step 450. In step 450, description encoder 150 uses another residual connection to add the output of step 430 with the output of step 440. As previously discussed in step 420, the summed vectors are normalized, resulting in description embedding 155.

Turning now to FIG. 5, a block diagram of an example of comparison engine 160 is shown. In the illustrated embodiment, graph assembler 130 receives locations embeddings 145 and description embedding 155 and produces locations 170. In some embodiments, comparison engine 160 is implemented differently than shown.

Comparison engine 160, in various embodiments, is software executable to generate locations 170 that identify a location corresponding to a segment of data within a hierarchical data set, based on similarity scores generated by comparing the description embedding 155 to the location embeddings 145. Comparison engine 160 receives location embeddings 145 and description embedding 155 from graph neural network algorithm 140 and description encoder 150 respectively. Comparison engine 160 measures the similarity between embedding 155 and 145 using a similarity function such as cosine similarity or Euclidean distance. Cosine similarity measures the similarity between the description embedding 155 and location embedding 145 by computing the cosine of the angle between the embeddings 145 and 155. A cosine value of 1 indicates that the embeddings 145 and 155 are identical, and a cosine value of −1 indicates that embeddings 145 and 155 are exact opposites. For example, if the angle between embedding 145 and 155 is smaller, the cosine value is closer to 1, and thus the embeddings are considered more similar. If the angle between embeddings 145 and 155 is greater, the cosine value is closer to −1, and thus the embeddings are considered less similar.

In other embodiments, engine 160 determines the similarity between a description embedding 155 and location embedding 145 by measuring the distance (e.g., Euclidean distance) between the two embeddings 145 and 155 in the embedding space. A greater distance between the embeddings 145 and 155 indicate that the embeddings are less similar while a smaller distance indicates that the embeddings are more similar. For example, if the distance between embedding 145 and 155 is zero, the embeddings are considered identical.

Comparison engine 160, in various embodiments, generates a similarity score per comparison, and the location embedding 145 with the highest score indicates that the particular location embedding 145 is the most similar to description embedding 155. Accordingly, a developer can locate the segment of data, described by the location request 120, within hierarchical data set 110 based on the similarity scores. For example, if a user submits an error report, a developer can locate the problematic function in code based on the description provided by the error report. In some embodiments, comparison engine 160 may not only output locations 170 but further rank them based on the determined similarities, which may be helpful when, for example, determining which code segment to review first when addressing a bug.

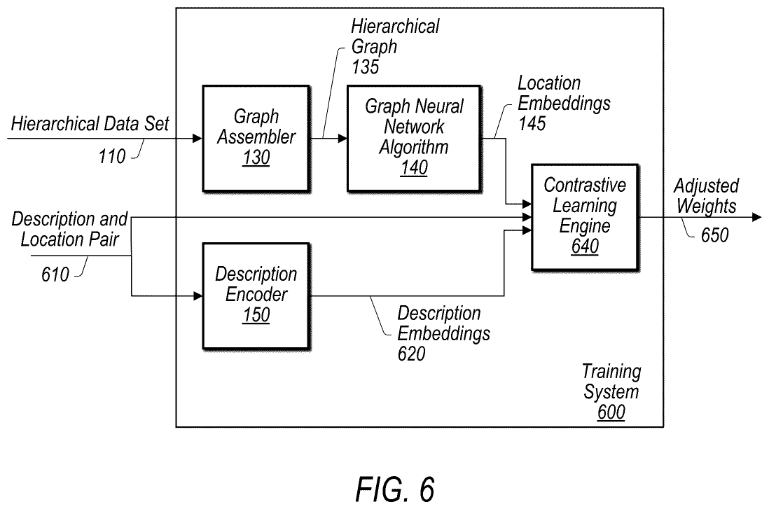

Turning now to FIG. 6, a block diagram of training system 600 is shown. In the illustrated embodiment, system 600 includes graph assembler 130, graph neural network algorithm 140, description encoder 150, and contrastive learning engine 640. As further shown, system 600 receives description and location pair 610. The illustrated embodiment may be implemented differently than shown. As an example, training system 600 may be a subsystem of system 100.

Training system 600, in various embodiments, is a system that trains graph neural network algorithm 140 and/or description encoder 150 based on training data such as description and location pairs 610. In the illustrated embodiment, description and location pairs 610 are textual descriptions and corresponding locations within a hierarchical dataset 110. For example, a given pair 610 may include a previously obtained error report with a textual description and the code segment identified by a developer in data set 110 as being the source of the error. While some pairs 610 include descriptions with relevant locations (referred to as positive pairs), other pairs 610 may include irrelevant information and be referred to as negative pairs 610. For example, a negative pair 610 can include an irrelevant code segment that does not address the error. The descriptions from pairs 610 can be provided to description encoder 150, and as previously described with FIG. 4, to obtain description embeddings 620. The location information from pair 610 is provided to contrastive learning engine 640.

Contrastive learning engine 640, in various embodiments, is software executable to generate adjusted weights 650 of neural networks used by algorithm 140 and/or encoder 150 using contrastive learning-based techniques. As discussed above with comparison engine 160, engine 640, in various embodiments, calculates a similarity score for each location embedding 145 vis-à-vis a given description embedding 620 using a similarity function such as cosine similarity or Euclidean distance. After calculating the similarity scores for a given description embedding 620, contrastive learning engine 640 uses a loss function, such as a symmetric cross entropy loss function, to calculate a loss value for each location embedding 145 based on that embedding 145's similarity score and the desired score based on the identified location in the pair 610. This loss value represents the error between a predicted similarity score (e.g., 0.1) and a desired similarity score for a given pair 610 (e.g., 1.0 if it is the identified location of a positive pair 610). Based on the loss value, engine 640 adjusts the set of weights, using backpropagation, to minimize the loss value by maximizing the similarity scores of positive pairs 610 and minimizing the similarity scores of negative pairs 610. Backpropagation is a technique for propagating the total loss value back into the neural network and adjusts the weights of system 100 accordingly. By adjusting the weights, engine 640 minimizes the distance (e.g., Euclidean distance) of positive pairs 610 and maximizes the distance of negative pairs 610 in the embedding space until an acceptable loss value is achieved.

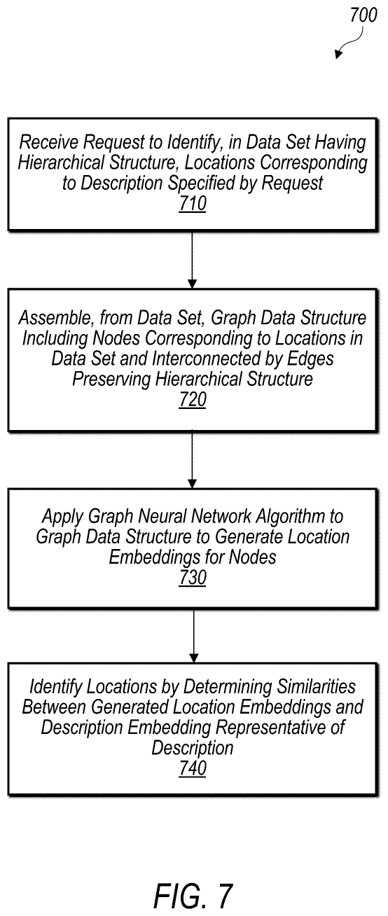

Turning now to FIG. 7, a flow diagram of a method 700 is shown. Method 700 is one embodiment of a method performed by a computing system 100. Method 700 may be performed by executing a set of program instructions stored on a non-transitory computer-readable medium.

Method 700 begins in step 710 with the computing system receiving a request (e.g., location request 120) to identify, in a data set (e.g., hierarchical data set 110) having a hierarchical structure, one or more locations corresponding to a description specified by the request.

In step 720, the computing system assembles (e.g., via graph assembler 130) a graph data structure (e.g., graph 135) that includes nodes (e.g., nodes 210) corresponding to locations in the data set and interconnected by edges (e.g., edges 220) preserving the hierarchical structure. In some embodiments, the data set is source code of an application, the nodes in the graph data structure represent functions defined in the source code, and the edges represent function calls made between the functions. In some embodiments, the description includes text identifying one or more attributes associated with the application; the identified one or more locations correspond to portions of the source code determined to be relevant to the one or more attributes.

In step 730, the computing system applying a graph neural network algorithm (e.g., algorithm 140) to the graph data structure to generate location embeddings (e.g., location embeddings 145) for the nodes. In some embodiments, applying the graph neural network algorithm includes determining node embeddings for nodes in the graph data structure and assigning nodes in the graph data structure to a plurality of pooling layers (e.g., abstraction levels in FIGS. 2 and 3) where the assigning further includes determining, for a given one of the pooling layers, clusters (e.g., clusters 340) for ones of the assigned nodes. In some embodiments, applying the graph neural network algorithm includes performing, for a given cluster, message passing between nodes within the given cluster, the message passing including applying one or more linear transformations and one or more non-linearities based on embeddings determined for the nodes in the given cluster. In some embodiments, applying the graph neural network algorithm includes calculating a location embedding for a given node assigned to a first of the plurality of pooling layers by combining the given node's embedding with an embedding determined by pooling nodes assigned to a given one of the clusters in a second of the plurality of pooling layers.

In step 740, the computing system identifies the one or more locations (e.g., locations 170) by determining similarities (e.g., via comparison engine 160) between the generated location embeddings and a description embedding (e.g., description embedding 155) representative of the description. In some embodiments, determining a given one of the similarities includes calculating a cosine similarity between a given one of the generated location embeddings and a description embedding representative of the description. In some embodiments, the identifying includes ranking the one or more locations based on the determined similarities.

In various embodiments, method 700 further includes the computing system applying a machine learning language model to the description to determine the description embedding, wherein the applying includes tokenizing the description to produce a plurality of tokens and supplying the plurality of tokens to an encoder (e.g., encoder 150) to produce the description embedding. In some embodiments, the encoder includes one or more self-attention layers and one or more feed-forward layers.

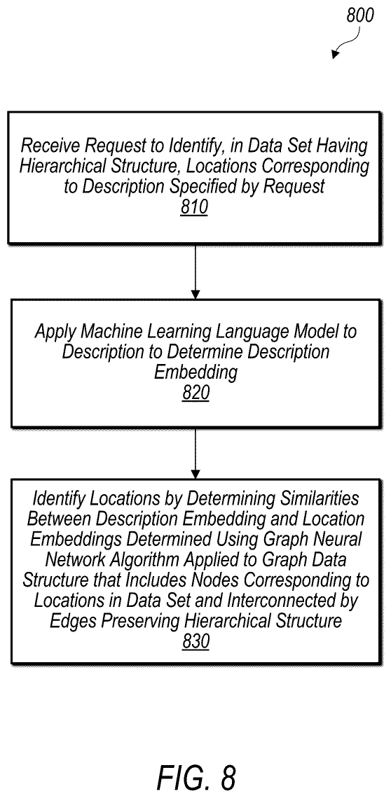

Turning now to FIG. 8, a flow diagram of a method 800 is shown. Method 800 is one embodiment of a method performed by a computing system 100. Method 800 may be performed by executing a set of program instructions stored on a non-transitory computer-readable medium.

Method 800 begins in step 810 with the computing system receiving a request (e.g., location request 120) to identify, in a data set (e.g., hierarchical data set 110) having a hierarchical structure, one or more locations corresponding to a description specified by the request.

In step 820, the computing system applies a machine learning language model (e.g., description encoder 150) to the description to determine a description embedding (e.g., description embedding 155). In some embodiments, the applying includes tokenizing the description to produce a plurality of tokens and supplying the plurality of tokens to an encoder (e.g., encoder 150) that includes one or more self-attention layers and one or more feed-forward layers.

In step 830, the computing system identifies the one or more locations (e.g., locations 170) by determining similarities (e.g., via comparison engine 160) between the description embedding and location embeddings (e.g., location embeddings 145) determined using a graph neural network algorithm (e.g., algorithm 140) applied to a graph data structure (e.g., graph 135) that includes nodes corresponding to locations in the data set and interconnected by edges preserving the hierarchical structure. In some embodiments, the data set is source code, the nodes in the graph data structure represent functions defined in the source code, and the description includes text identifying one or more attributes associated with the source code. In some embodiments, the graph neural network algorithm assigns nodes in the graph data structure to a plurality of pooling layers (e.g., abstract levels) and determines, for a given one of the pooling layers, clusters (e.g., clusters 340) for ones of the assigned nodes for message passing. In some embodiments, the computing system ranks the one or more locations based on the determined similarities.

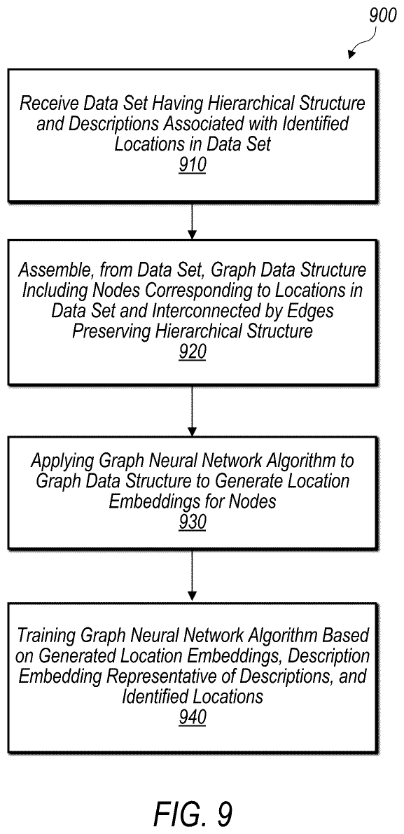

Turning now to FIG. 9, a flow diagram of a method 900 is shown. Method 900 is one embodiment of a method performed by a computing system 100. Method 900 may be performed by executing a set of program instructions stored on a non-transitory computer-readable medium.

Method 900 begins in step 910 with the computing system receiving a data set (e.g., hierarchical data set 110) having a hierarchical structure and descriptions associated with identified locations (e.g., description and location pairs 610) in the data set.

In step 920, the computing system assembles, from the data set, a graph data structure (e.g., hierarchical graph 135) that includes nodes (e.g., nodes 210) corresponding to locations in the data set and interconnected by edges (e.g., edges 220) preserving the hierarchical structure. In some embodiments, the data set is source code of an application, the edges in the graph data structure include edges that represent function calls in the source code, and the descriptions include texts identifying attributes associated with the application.

In step 930, the computing system applies a graph neural network algorithm (e.g., algorithm 140) to the graph data structure to generate location embeddings (e.g., location embeddings 145) for the nodes. In some embodiments, the computing system determines node embeddings for nodes in the graph data structure, assigns nodes in the graph data structure to a plurality of pooling layers (e.g., abstraction levels), and performs message passing between nodes within a given pooling layer.

In step 940, the computing system trains the graph neural network algorithm based on the generated location embeddings, description embedding representative of the descriptions, and the identified locations. In some embodiments, the training includes applying a contrastive learning algorithm (e.g., via engine 640) using the location embeddings, the description embeddings, and the identified locations.

In some embodiments, method 900 further includes the computing system receiving a request (e.g., location request 120) to identify, in the data set, one or more locations corresponding to a description specified by the request and identifying the one or more locations (e.g., locations 170) by determining similarities between generated location embeddings and a description embedding (e.g., description embedding 155) representative of the description.

### Exemplary Computer System

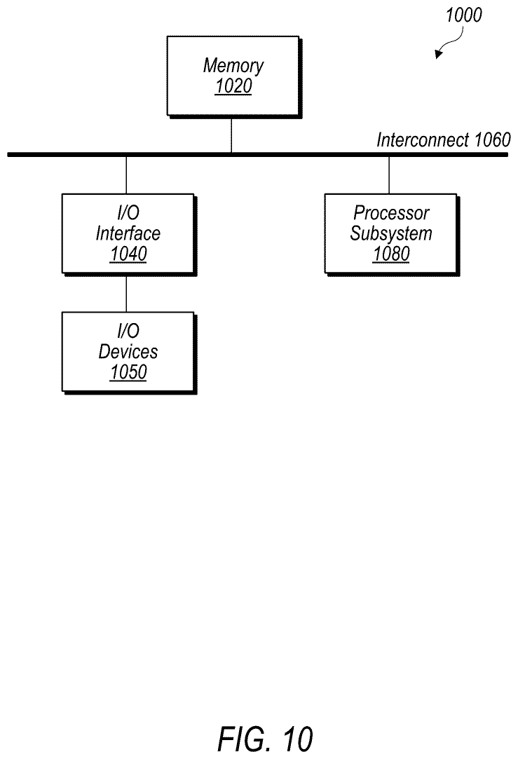

Turning now to FIG. 10, a block diagram of an exemplary computer system 1000, which may implement system 100 (or one or more components included in system 100), is depicted. Computer system 1000 includes a processor subsystem 1080 that is coupled to a system memory 1020 and I/O interfaces(s) 1040 via an interconnect 1060 (e.g., a system bus). I/O interface(s) 1040 is coupled to one or more I/O devices 1050. Although a single computer system 1000 is shown in FIG. 10 for convenience, system 1000 may also be implemented as two or more computer systems operating together.

Processor subsystem 1080 may include one or more processors or processing units. In various embodiments of computer system 1000, multiple instances of processor subsystem 1080 may be coupled to interconnect 1060. In various embodiments, processor subsystem 1080 (or each processor unit within 1080) may contain a cache or other form of on-board memory.

System memory 1020 is usable store program instructions executable by processor subsystem 1080 to cause system 1000 perform various operations described herein. System memory 1020 may be implemented using different physical memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 1000 is not limited to primary storage such as memory 1020. Rather, computer system 1000 may also include other forms of storage such as cache memory in processor subsystem 1080 and secondary storage on I/O Devices 1050 (e.g., a hard drive, storage array, etc.). In some embodiments, these other forms of storage may also store program instructions executable by processor subsystem 1080. In some embodiments, program instructions that when executed implement elements 130-160 may be included/stored within system memory 1020.

I/O interfaces 1040 may be any of various types of interfaces configured to couple to and communicate with other devices, according to various embodiments. In one embodiment, I/O interface 1040 is a bridge chip (e.g., Southbridge) from a front-side to one or more back-side buses. I/O interfaces 1040 may be coupled to one or more I/O devices 1050 via one or more corresponding buses or other interfaces. Examples of I/O devices 1050 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 1000 is coupled to a network via a network interface device 1050 (e.g., configured to communicate over Wi-Fi®, Bluetooth®, Ethernet, etc.).

The present disclosure includes references to “embodiments,” which are non-limiting implementations of the disclosed concepts. References to “an embodiment,” “one embodiment,” “a particular embodiment,” “some embodiments,” “various embodiments,” and the like do not necessarily refer to the same embodiment. A large number of possible embodiments are contemplated, including specific embodiments described in detail, as well as modifications or alternatives that fall within the spirit or scope of the disclosure. Not all embodiments will necessarily manifest any or all of the potential advantages described herein.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112 (f) for that claim element. Should Applicant wish to invoke Section 112(f) during prosecution of a United States patent application based on this disclosure, it will recite claim elements using the “means for” [performing a function] construct.

What is claimed is:

1. A non-transitory computer readable medium having program instructions stored therein that are executable by a computing system to perform operations comprising:
receiving a request to identify, in a data set having a hierarchical structure, one or more locations corresponding to a description specified by the request;
assembling, from the data set, a graph data structure that includes nodes corresponding to locations in the data set and interconnected by edges preserving the hierarchical structure;
applying a graph neural network algorithm to the graph data structure to generate location embeddings for the nodes; and
identifying the one or more locations by determining similarities between the generated location embeddings and a description embedding representative of the description.

2. The computer readable medium of claim 1, wherein the data set is source code of an application;
wherein the nodes in the graph data structure represent functions defined in the source code; and
wherein the edges represent function calls made between the functions.

3. The computer readable medium of claim 2, wherein the description includes text identifying one or more attributes associated with the application; and
wherein the identified one or more locations correspond to portions of the source code determined to be relevant to the one or more attributes.

4. The computer readable medium of claim 1, wherein applying the graph neural network algorithm includes:
determining node embeddings for nodes in the graph data structure; and
assigning nodes in the graph data structure to a plurality of pooling layers, wherein the assigning further includes determining, for a given one of the pooling layers, clusters for ones of the assigned nodes.

5. The computer readable medium of claim 4, wherein applying the graph neural network algorithm includes:
performing, for a given cluster, message passing between nodes within the given cluster, wherein the message passing includes applying one or more linear transformations and one or more non-linearities based on embeddings determined for the nodes in the given cluster.

6. The computer readable medium of claim 4, wherein applying the graph neural network algorithm includes:
calculating a location embedding for a given node assigned to a first of the plurality of pooling layers by combining the given node's embedding with an embedding determined by pooling nodes assigned to a given one of the clusters in a second of the plurality of pooling layers.

7. The computer readable medium of claim 1, wherein the operations further comprise:
applying a machine learning language model to the description to determine the description embedding, wherein the applying includes:
tokenizing the description to produce a plurality of tokens; and
supplying the plurality of tokens to an encoder to produce the description embedding.

8. The computer readable medium of claim 7, wherein the encoder includes one or more self-attention layers and one or more feed-forward layers.

9. The computer readable medium of claim 1, wherein determining a given one of the similarities includes:
calculating a cosine similarity between a given one of the generated location embeddings and a description embedding representative of the description.

10. The computer readable medium of claim 1, wherein the identifying includes ranking the one or more locations based on the determined similarities.

11. A computing system, comprising:
one or more processors; and
memory having program instructions stored therein that are executable by the one or more processors to perform operations that include:
receiving a request to identify, in a data set having a hierarchical structure, one or more locations corresponding to a description specified by the request;
applying a machine learning language model to the description to determine a description embedding; and
identifying the one or more locations by determining similarities between the description embedding and location embeddings determined using a graph neural network algorithm applied to a graph data structure that includes nodes corresponding to locations in the data set and interconnected by edges preserving the hierarchical structure.

12. The computing system of claim 11, wherein the data set is source code, the nodes in the graph data structure represent functions defined in the source code, and the description includes text identifying one or more attributes associated with the source code.

13. The computing system of claim 11, wherein the graph neural network algorithm assigns nodes in the graph data structure to a plurality of pooling layers and determines, for a given one of the pooling layers, clusters for ones of the assigned nodes for message passing.

14. The computing system of claim 11, wherein the applying includes:
tokenizing the description to produce a plurality of tokens; and
supplying the plurality of tokens to an encoder that includes one or more self-attention layers and one or more feed-forward layers.

15. The computing system of claim 11, wherein the operations further comprise:
ranking the one or more locations based on the determined similarities.

16. A method, comprising:
receiving, by a computing system, a data set having a hierarchical structure and descriptions associated with identified locations in the data set;
assembling, by the computing system and from the data set, a graph data structure that includes nodes corresponding to locations in the data set and interconnected by edges preserving the hierarchical structure;
applying, by the computing system, a graph neural network algorithm to the graph data structure to generate location embeddings for the nodes; and
training, by the computing system, the graph neural network algorithm based on the generated location embeddings, description embedding representative of the descriptions, and the identified locations.

17. The method of claim 16, wherein the training includes applying a contrastive learning algorithm using the location embeddings, the description embeddings, and the identified locations.

18. The method of claim 16, further comprising:
receiving, by the computing system, a request to identify, in the data set, one or more locations corresponding to a description specified by the request; and
identifying, by the computing system, the one or more locations by determining similarities between generated location embeddings and a description embedding representative of the description.

19. The method of claim 16, wherein the data set is source code of an application;
wherein the edges in the graph data structure include edges that represent function calls in the source code; and
wherein the descriptions include texts identifying attributes associated with the application.

20. The method of claim 16, further comprising:
determining, by the computing system, node embeddings for nodes in the graph data structure;
assigning, by the computing system, nodes in the graph data structure to a plurality of pooling layers; and
performing, by the computing system, message passing between nodes within a given pooling layer.
